(19) United States
(12) Patent Application Publication
(10) Pub. No.: US 2006/0026119 A1
(43) Pub. Date: Feb. 2, 2006

(54) Method and system for sharing information about media items

(75) Inventors: Payam Mirrashidi, San Francisco, CA (US); Chris Bell, Pacifica, CA (US)

Correspondence Address: BEYER WEAVER & THOMAS LLP, P.O. BOX 70250, OAKLAND, CA, 94612-0250, US

(73) Assignee: Apple Computer, Inc., Cupertino, CA (US)

(21) Appl. No.: 10/910,555

(22) Filed: Aug. 2, 2004

(51) Int. Cl. G06F 17/30

(52) U.S. Cl. 707/1

(57) ABSTRACT

A method for sharing information between users of a media management application is disclosed. In one embodiment, a server computer receives a media information share request, retrieves artist or album information according to the media information share request, constructs a media message form containing artist or album information according to the media information share request and blanks boxes for the user to enter a plurality of recipient e-mail addresses, the user's name and e-mail address, and a message to the recipients, and sends the completed media message form to the client computer. The server computer then receives a completed media message form from a client computer, constructs a media message containing artist or album information according to the media message form, extracts a list of e-mail addresses from the media message form, selects an e-mail address from the list of e-mail addresses and sends a media message to each e-mail address in the list of e-mail addresses.

### BACKGROUND OF THE INVENTION

1. Field of the Invention

The present invention relates to media information and, more specifically, to providing media related information to others.

2. Description of the Related Art

It is becoming increasingly more common for consumers looking to purchase media items such as music, videos, or books, to shop for media online. During the course of shopping, a user of an online media store might come across a media item and wish to share information regarding that media item with another person. One method of sharing information about media items uses a web-browser to send a message via e-mail. The e-mail message contains information about a media item and a link to a web site where the recipient of the e-mail message may purchase the media item.

There are many disadvantages to current methods of sharing information about media items. Mostly, these disadvantages involve the difficulty in getting a host of programs to work with each other. For instance, the most common way of obtaining media items is to download the media items via a web browser application. However, web browsers are general-purpose applications unsuitable for use as media players, so the user will likely also employ a media player such as MusicMatch Jukebox, RealPlayer, or Windows Media Player. Thus, a user will commonly buy a media item at a web site, download the media item to a personal computer, and manage the media using a media player. This problem remains when sending a media information message to another user. Namely, the message containing media item information will require an e-mail application to view the message, a web browser to buy and download the media item, and a media player to play the media item.

In order to bypass some of the problems mentioned above, some consumers use a media management application such as iTunes™, distributed by Apple Computer, Inc. of Cupertino, Calif., instead of a typical web browser/media player combination. iTunes™ incorporates an online media store and integrates the functions of web browser and media player into a single software application, thereby allowing the user to search or browser media items, to preview media items before purchase, to purchase desired media items, to download purchased media items, and to play downloaded media items.

Conventional methods of communicating information about a media item are limited to information regarding a single media item and are fairly unsophisticated in execution. A consumer using one of the conventional methods cannot, for instance, use an existing media information sharing method to compose an e-mail that will contain a link that will open the recipient's media management application rather than merely opening a web browser. Moreover, an e-mail using one of the current methods will contain a link only to a single media item. Furthermore, the conventional methods only allow a message to be sent to a single recipient. If a user wants to specify multiple recipients, each recipient must be sent in a separate e-mail.

Accordingly, there is a need for improved techniques to implement a means of communicating information about one or more media items to multiple recipients via e-mail and to facilitate viewing those media items using a media management application instead of a web-browser in combination with a media player.

### SUMMARY OF THE INVENTION

The present invention relates to sharing information between users of a media management application. In one embodiment, a sophisticated media information message can be sent simultaneously to multiple e-mail recipients.

The invention can be implemented in numerous ways, including as a method, system, device, apparatus, graphical user interface, or computer readable medium. Several embodiments of the invention are discussed below.

According to one embodiment of the invention, a user browses or searches for media items in a media repository using a client application. The user, upon receiving information regarding one or more media items which are displayed by the client application, chooses to send a media information share request to a remote server computer, which causes that remote server computer to send a media message form back to the client application. Upon receipt of the media message form, the client application displays the media message form including media item information pertaining to one or more of the plurality of media items associated with the media information share request. The media message form also includes a plurality of text fields that are to be filled out by the user. One of these text fields is a list of one or more destination e-mail addresses. When the user has finished entering the requested information into the media message form, the user requests that the completed media message form be sent to recipients as specified when filling out the media message form. When the client application detects that a request has been made, the media message is submitted to the server computer for transmission to one or more recipients.

According to another embodiment of the invention, a server computer receives a media information share request for artist or album information from a client computer, retrieves the requested information, constructs a media message form with the artist or album information and blank text boxes wherein the user can enter a plurality of recipient e-mail addresses as well as other information, and sends the completed media message form to the client computer. Later, after the media message form has been completed at the client computer and sent by the client application, the server receives a completed media message form, constructs a media message, extracts a list of e-mail addresses which were previously entered after client computer, selects one of the e-mail addresses, sends a media message to the selected e-mail address, and then repeats the process for every e-mail address in the list of e-mail addresses.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIGS. 1A and 1B are flow diagrams representing a media information sharing process according to one embodiment of the invention.

FIG. 1C is a flow diagram representing a media information sharing process according to one embodiment of the invention.

FIG. 2 is an example of a blank media message form according to one embodiment of the invention.

FIG. 3 is a flow diagram of a server-side media information sharing process according to one embodiment of the invention

FIG. 4A is a flow diagram of a media message form creation process according to one embodiment of the invention

FIG. 4B is a flow diagram of a media message creation process according to one embodiment of the invention

FIG. 5 is a block diagram of a computer network according to one embodiment of the invention.

FIG. 6 shows an exemplary computer system suitable for use with the invention.

### DETAILED DESCRIPTION OF THE INVENTION

The invention pertains to improved techniques for sharing media file information between users of a media management application. The improved techniques enable a user to send information regarding, for instance, a plurality of media items (e.g., music albums by a particular artist) to a plurality of e-mail addresses at the same time.

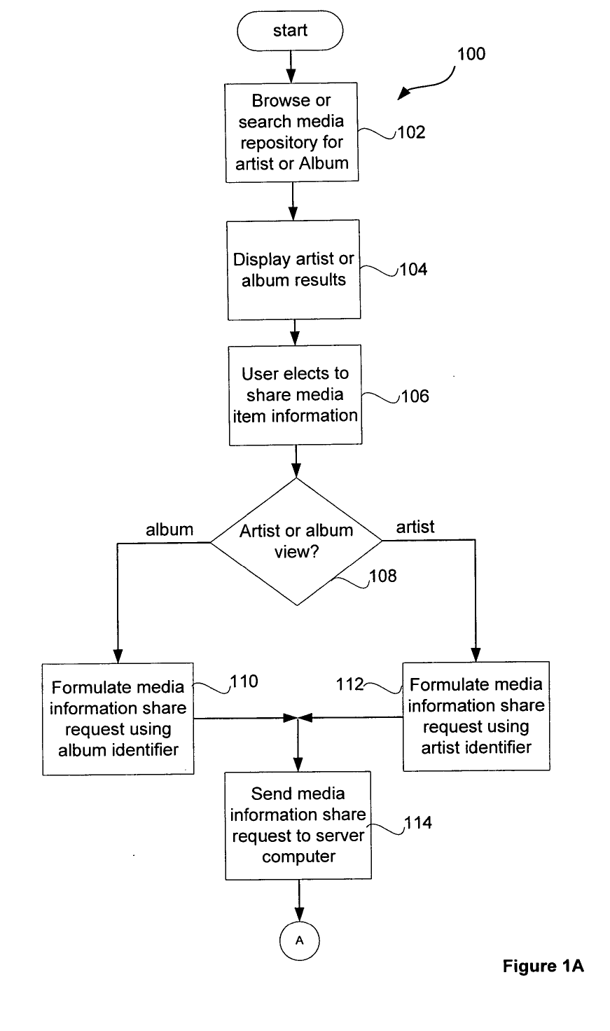

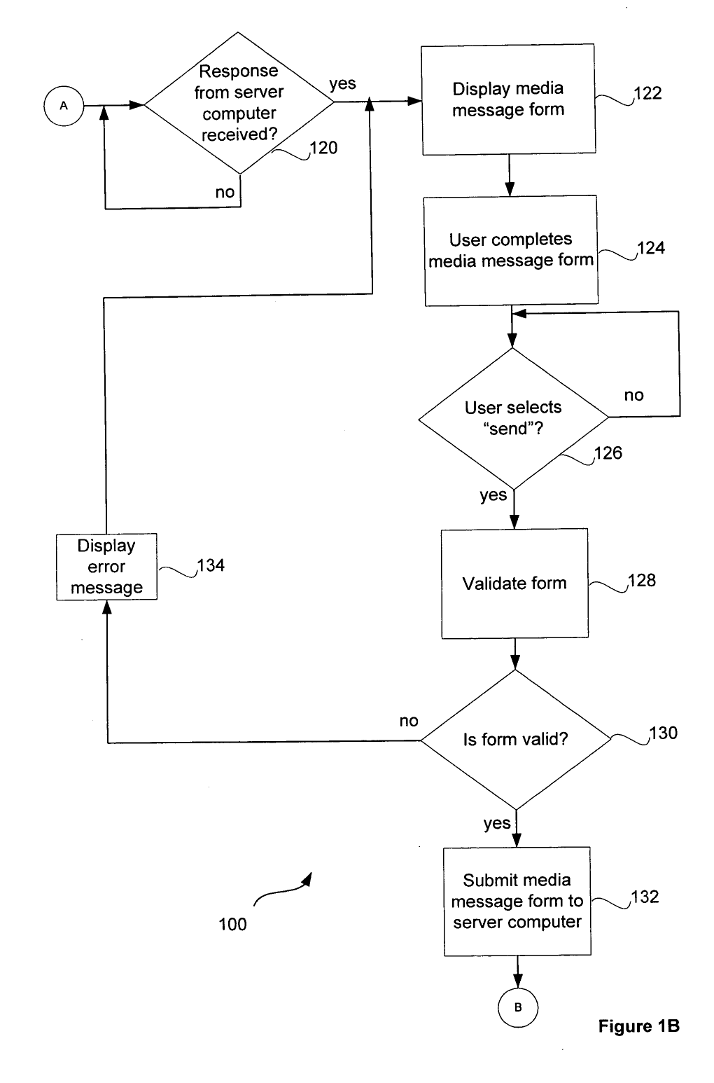

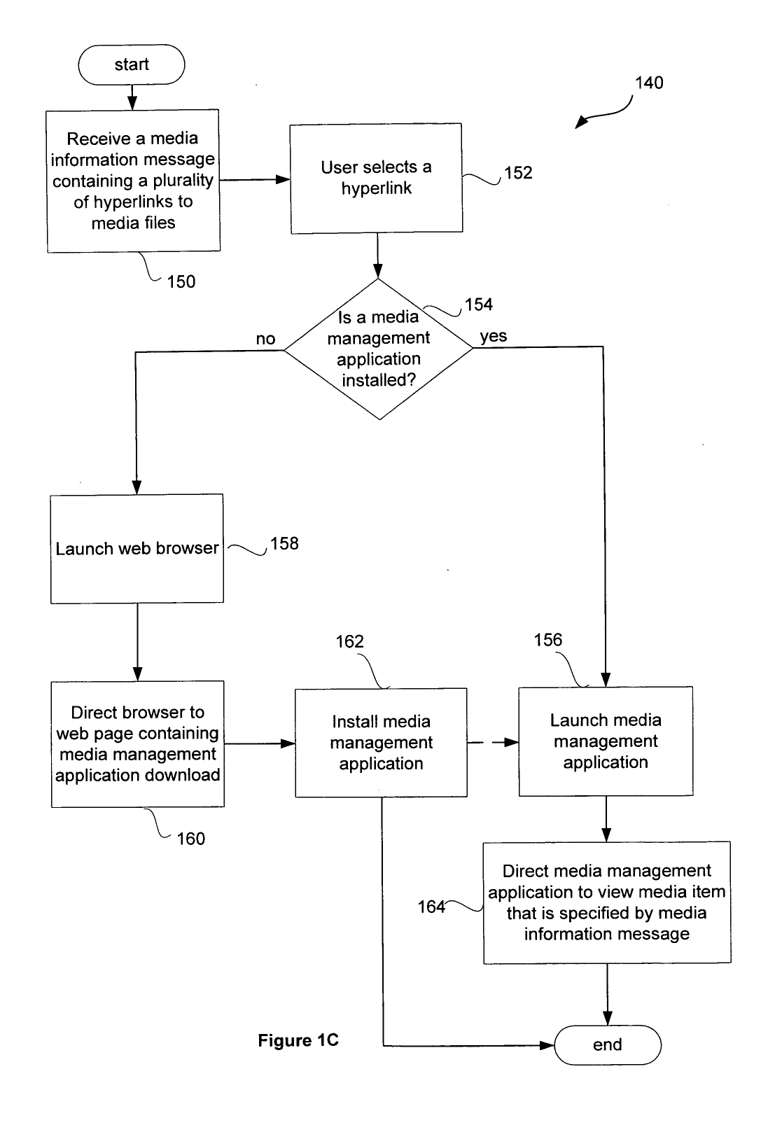

FIGS. 1A, and 1B illustrate flow diagrams divided into three parts representing a media information sharing process 100 according to one embodiment of the invention. In this case a media management application such as, for example, iTunes™ produced by and available from Apple Computer, Inc. of Cupertino, Calif., is used to share information about a particular media item with one or more other users. In particular, FIGS. 1A and 1B detail the sharing of information regarding music files. However, those skilled in the art will recognize that information about other types of media items can be shared in the same manner.

The media information sharing process 100 begins with a user employing a client application, such as a media management application, to browse or search 102 for media items in a media repository such as an on-line music store. Here, the user is browsing or searching to look for information about a particular artist, album, or song. The browse or search is processed at the media repository and results are returned to the client application where they are displayed 104 to the user. For example, the results of the browse or search can be displayed 104 on a media display page. At this point, the user may decide to formulate another search, buy one or more of the displayed media items, or elect to share information regarding a media item via e-mail to another person. Also, depending on the whether the user is searching or browsing, and which search terms or what path the user followed to get to the media display page, the media display page being displayed can show information regarding a particular album or information regarding albums by a particular artist. For example, the user may be looking at a media display page with songs associated with a particular album or at a page with songs associated with a particular artist.

If the user is viewing a page containing artist information, multiple albums of songs by that artist may be displayed. However, if the user is looking at a page with songs associated with a particular album, one album will be displayed. Regardless of which view the user is in, in one implementation of the present invention, a link allowing the user to share information about a particular album or artist is located on the media display page. In one embodiment of the present invention, this link is labeled “Tell-a-Friend”. If the user elects to share information about the album or artist 106 (i.e., by selecting the Tell-a-Friend link on the media display page), the media information sharing process 100 determines 108 whether the user is in artist or album view. If the user is in artist view, a media information share request is formulated 110 using an artist identifier. Otherwise, if the user is in album view, the media information share request is formulated 112 using an album identifier. Artist and album identifiers are collectively referred to in this application as media identifier types. It is clear that other media identifier types (e.g., video) may be used. At this point, the media information share request is sent 114 to a server computer and the media information sharing process 100 continues to decision 120, which is shown on FIG. 1B.

At the decision 120, the media information sharing process 100 determines if a response has been received from the server computer. When a response is received, a media message form is displayed 122 in the client application.

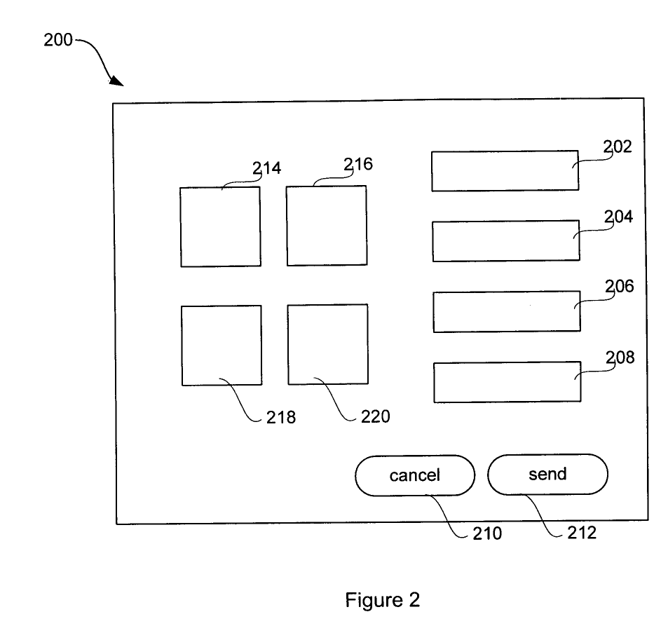

An example of a sample blank media message form 200 according to one embodiment of the invention is shown in FIG. 2. The sample media message form 200 contains blank text fields that the user can complete in order to provide a text message as well as to properly route a media message to one or more other users. These text fields may include, but are not limited to: sender's name field 202, sender's e-mail address field 204, and optional message field 206. Additionally, the media message form 200 contains a recipient e-mail address field 208 in which the user may enter one or more e-mail addresses, one for each intended recipient of the media message. In one embodiment of the invention, multiple e-mail addresses can be entered in the recipient e-mail address field in a comma delimited manner (i.e. separated by commas.) However, a person of ordinary skill in the art would understand that other means of delimiting multiple e-mail addresses, such as semi-colons or spaces, could be used. Note further, that while the media message form 200 is shown initially blank, in one embodiment of the invention, the form may be pre-populated with the user's relevant information (i.e., sender's name and e-mail address). For example, if the user has logged into the media repository, the media message form 200 can typically be partially pre-populated. The media message form 200 also has, in one embodiment, a “cancel” button 210 and a “send” button 212. The “cancel” button 210 interrupts the media information sharing process 100 discussed above and, for example, re-displays a previously display page for the user. The “send” button 212 allows the user to submit the completed media message request form. As shown in FIG. 2, the media message form 200 can also contain information about media items that the sender desires to inform the one or more recipients about. In this example, the media message form 200 includes media item information blocks 214, 216, 218 and 220. In one embodiment of the present invention, the media item information blocks 214, 216, 218 and 220 contain information about collections of media items (e.g., media albums).

Referring back now to FIG. 1B, the media information sharing process 100 continues with the user completing 124 the media message form, such as by filling in the blank fields (e.g., text boxes 202-208). The media information sharing process 100 then determines 126 whether the user has decided to send the media message form. Here, as an example, the user can select the “send button” 210 discussed above in reference to FIG. 2 when the user desires to send the media message form. Once the media information sharing process 100 detects that the user has completed and elected to send the media message form 200, then the media message form 200 is validated 128. The validation operation 128 can include various checks including, according to one embodiment of the invention, ensuring all blanks in the media message form are properly completed. Next, a decision 130 determines if the media message form was successfully validated. If validation is successful, then the media information sharing process 100 submits 132 the media message form to a server computer and the media information sharing process 100 ends. On the other hand, if validation fails for some reason, an error message is displayed 134 and the media information sharing process 100 returns to repeat the block 122 and subsequent blocks.

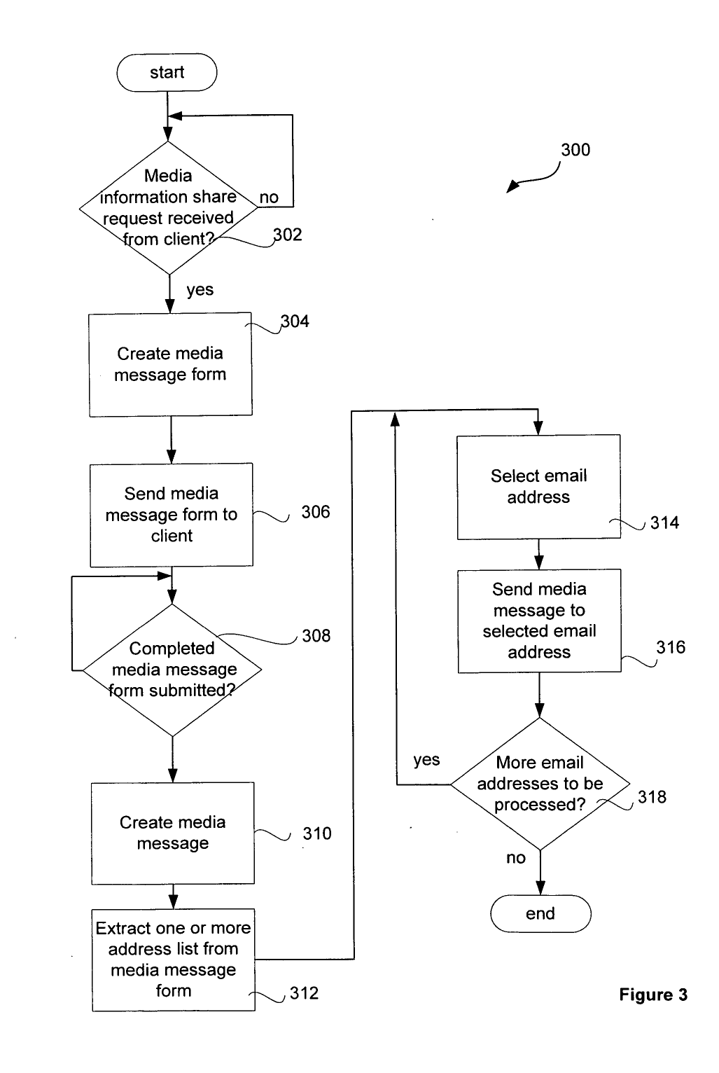

FIG. 1C is a flow diagram of a media message receipt process 140 according to one embodiment of the invention. The media message receipt process 140 once a media information request has been processed and sent out to the recipients as described below with reference to FIG. 3.

The media message receipt process 140 begins when a media information message is received 150 by an e-mail application operating on a client computer of a recipient. The media information message contains a plurality of hyperlinks and, depending on the settings of the client e-mail application, may be displayed in text-only (plain-text) or graphics and text (e.g. HTML) format. Next, at 152, a user selects a hyperlink in the media information message. A decision 154 then determines if a media management application (e.g. iTunes™) is installed. This determination may be accomplished by various means, as will be understood by those familiar with the art of computer programming. For example, in one embodiment of the invention, where the e-mail is received by a client computer operating the Microsoft Windows™ operating system, the determination can be accomplished by launching a web-browser which contains an ActiveX™ control to determine if a particular program has been installed. If the decision 154 determines that a media management media management application has been installed, then the application is launched 156 and directed 164 to view the decision at least one media item that was specified by the media information message. If, however, the decision 154 determines that a media management application has not been installed, then a web browser application is launched 158 on the client computer and the browser is directed 160 to a web page that contains a link allowing the user to download a media management application. Once the media management application has been downloaded, it is installed 162 on the client application. Following the blocks 162 and 164, the media message process 140 ends. However, one skilled in the art will recognize that it is possible to cause the media information management application to launch 156 automatically upon installation (see dashed line between block 162 and 156) and then direct 164 the media management application to view the media item that was the subject of the media message.

FIG. 3 is a flow diagram of a server-side media information sharing process 300 according to one embodiment of the invention.

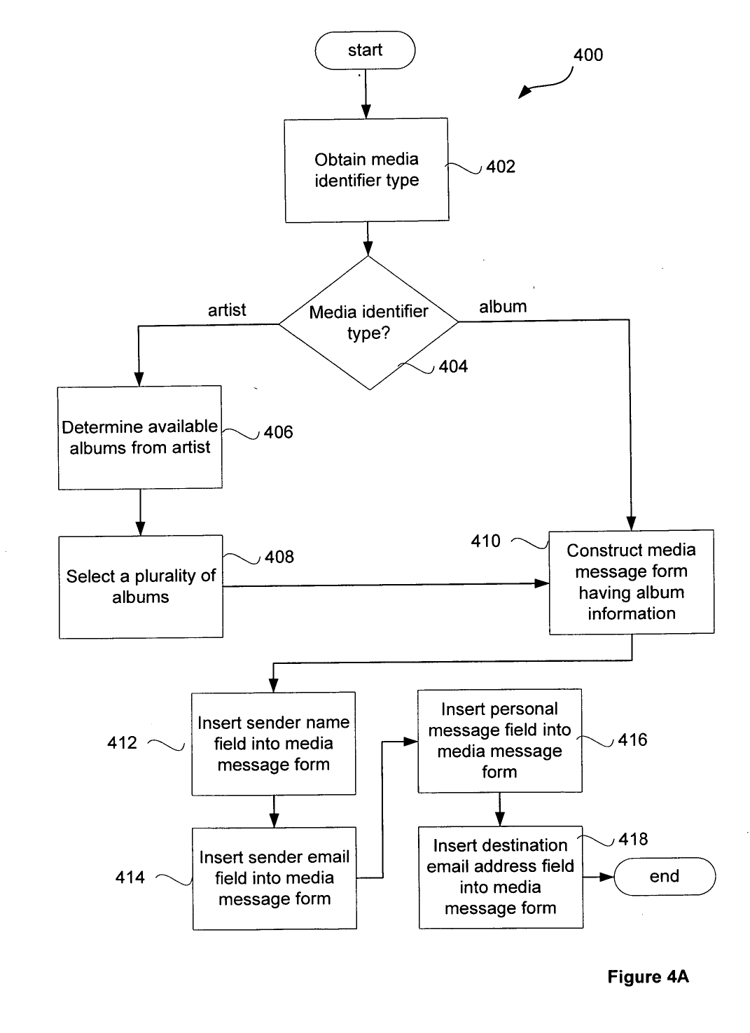

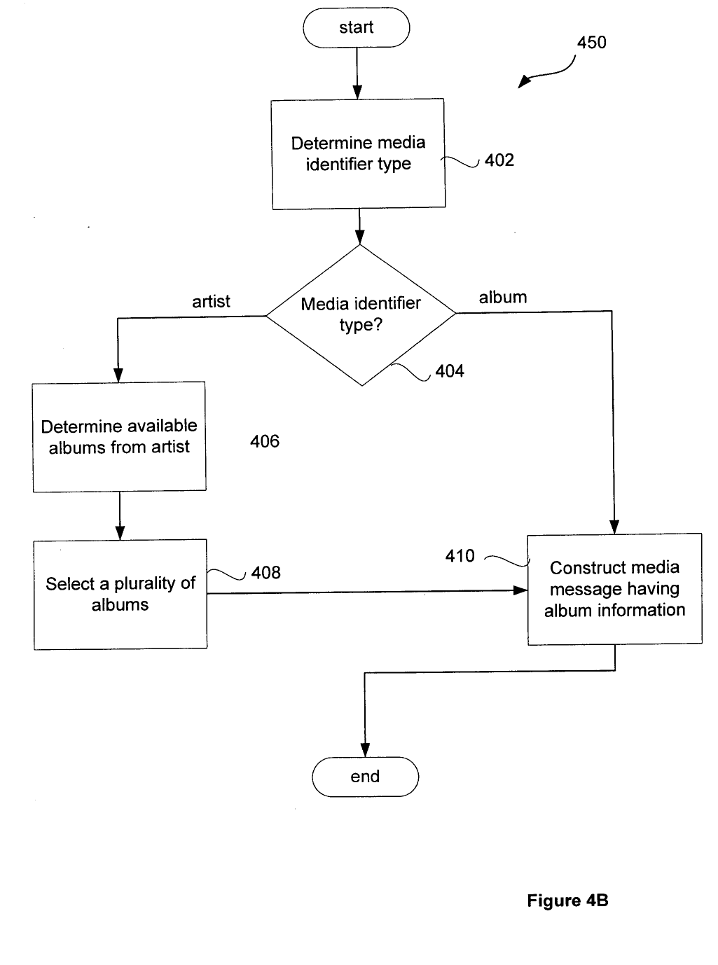

The server-side media information sharing process 300 begins with a determination 302 of whether a media information share request from a client computer has been received at the server computer. If not, the server-side media information sharing process 300 waits until a request has been received. Once a media information share request has been received, a media message form is created 304. A media message form contains information about one or more media items as selected by a user of a requesting client application. One embodiment of a media message form creation process is described below in reference to FIG. 4A. After the media message form is created 304, the media message form is sent 306 to the client computer. Typically, media message form would thereafter be presented to the user of the client computer who would then complete the media message form by entering information into one or more fields (e.g., text boxes), and then submit the media message form.

After the media message form has been sent 306, a decision 308 determines if a completed media message form has been submitted by a client computer. Once the decision 308 determines that a complete media message form has been submitted, a media message is created 310 according to information provided in the completed media message form. One embodiment of a media message creation process used to create the media message is described below in reference to FIG. 4B. The media message will also typically include any personal message that was present in the completed media form. In one embodiment, the media message itself can be created in both plain-text and HTML formats. Depending on the settings of the recipient's e-mail program, the message will either appear as a series of hyperlinks in text form, or as a multi-media message containing graphics and text.

The construction of the media message is followed by the extraction 312 of one or more destination e-mail addresses from the completed media message form. In one embodiment, the one or more destination e-mail addresses are provided as a list within the completed media message form.

Next, an e-mail address is selected 314 from the one or more destination e-mail addresses and the media message is sent 316 to the selected e-mail address. A decision 318 then determines if there are any more destination e-mail addresses to be processed. If not, the server-side media information sharing process 300 ends. Otherwise, the server-side media information sharing process returns to repeat block 314 and subsequent blocks so as to send a media message to another destination e-mail address.

FIG. 4A is a flow diagram of a media message form creation process 400 according to one embodiment of the invention. The media message form creation process 400 begins by obtaining 402 a media identifier type contained in the media information share request. For example, this may involve parsing the media information share request. As discussed above in reference to FIG. 1A, the media identifier type can be either an artist identifier that identifies a particular artist or an album identifier that identifies a particular album. More generally, a media identifier type can signal a context for the media information share request that eventually causes a media message to be sent. If the media identifier type is an artist identifier, then decision 404 directs the media message form creation process 400 to determine 406 the available albums from that particular artist are determined. As an example, the available albums can be available for purchase at an on-line music store. Next, a plurality of albums are selected 408 using a selection criteria. This selection criteria could, for instance, be the latest albums by that artist, or possibly the best selling (i.e., most popular) albums by that artist. A media message form having information about at least the selected albums is then constructed 410. On the other hand, if the media identifier type is an album identifier, then the media message form creation process 400 simply uses the particular album identified by the album identifier to construct 410 the media message form.

Next, fields are inserted into the media message form in blocks 412 through 418. These blocks are shown in a particular order in FIG. 4A. However, it should be understood that these blocks 412 through 418 are exemplary and may be performed in any order. As shown, the sender name field is inserted 412 into the media message form, followed by the insertion 414 of the sender e-mail filed, the insertion 416 of a personal message field, and the insertion 418 of an e-mail destination address field. When all the fields to be provided have been inserted, the media message form creation process 400 ends.

FIG. 4B is a flow diagram of a media message creation process 450 according to one embodiment of the invention. As shown in this embodiment, the media message creation process 450 is similar to the media message form creation process 400, at which point the media message creation process 450 ends. Here the information obtained by the media message form creation from block 402-410 by process 400 has already been entered into the media message form and will be used by the server-side media information sharing process 300 shown in FIG. 3 to create the media message

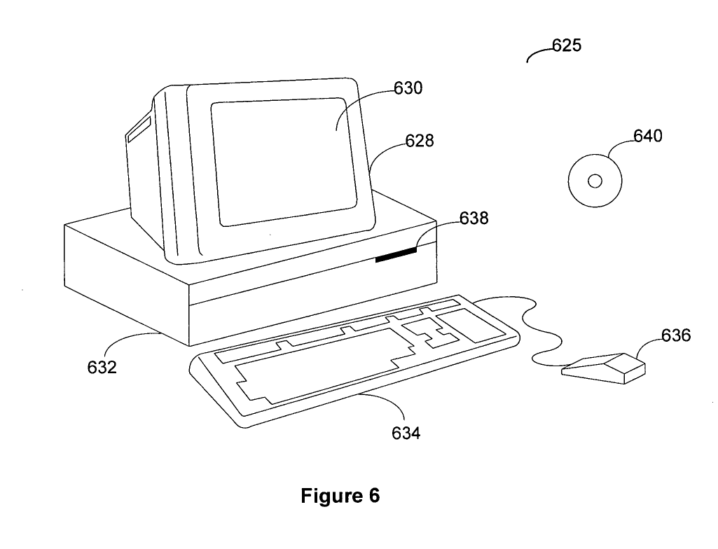

FIG. 6 is a block diagram of a computer network 600 according to one embodiment of the invention. The computer network 600 includes one or more servers 610. Additionally, the network includes a media repository 620 (i.e. online music store), which is usually a server as well. Typically, the computer network 600 would include a plurality of different clients 604. Each client 604 includes one or more client applications. The client applications are application programs such as a media management application 624, a web browser (not shown), and an e-mail client application 622 that operate on clients 604, which is are computing devices. Clients 604 are coupled to the servers 602 through a data network 606. Hence, a user operating a client 604 can browse media repository 620 using a media management application 624. A media information message can be formulated as described above in reference to FIGS. 1A- 4B and sent to client 604′. A user on client 604′ can view the message in an e-mail client application 622′ and view the subject matter of the media information message in a media management application 624′. Note that, in one embodiment of the present invention, media management applications 624 and 624′ are the same application operating on separate computers, but this is not necessary to practice the invention. The media management application could be a different application, or the same application on the same client computer with the same or a different user. In one embodiment, the data network 606 includes at least a portion of the Internet. The clients 604 can vary with application but generally are computing devices that have memory storage (e.g., both volatile and non-volatile). Often, the clients 604 are personal computers or other computing devices.

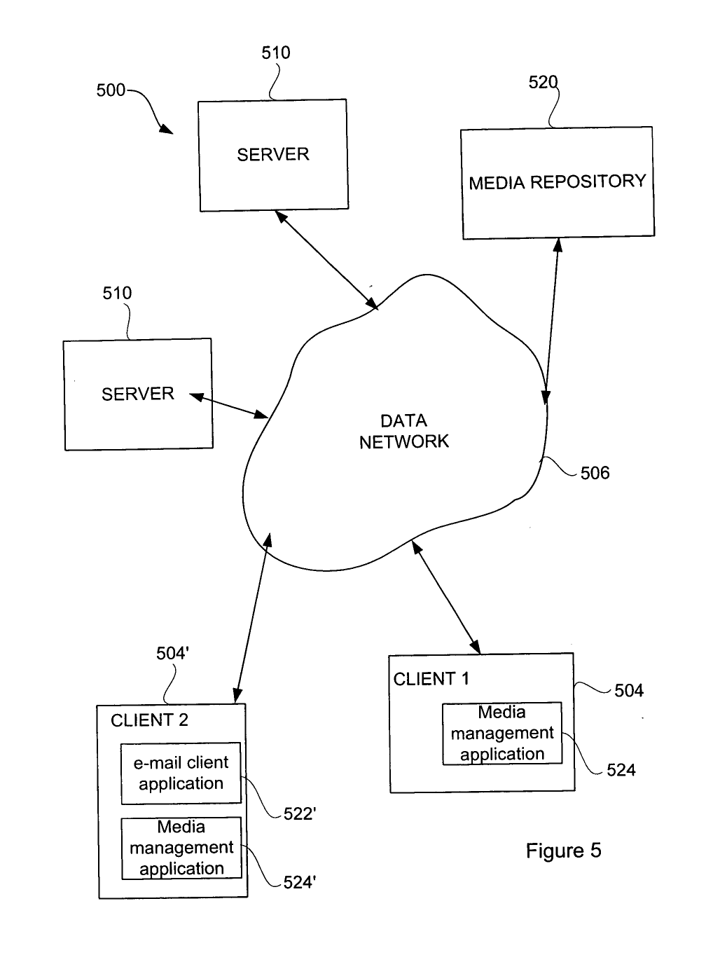

FIG. 5 shows a computer system 525 that includes a display monitor 528 having a single or multi-screen displays 530 (or multiple displays), cabinet 532, keyboard 534, and mouse 536. Cabinet 532 houses a drive 538, such as a CD-ROM or floppy drive, system memory and a hard drive (not shown) which may be utilized to store and retrieve software programs incorporating computer code that implements the present invention, data for use with the invention, and the like. Although CD-ROM 540 is shown as an exemplary computer readable storage medium, other computer readable storage media including floppy disk, tape, flash memory, system memory, and hard drive may be utilized. Additionally, a data signal embodied in a carrier way (e.g., in a network including the Internet) may be the computer readable storage medium. In one implementation, an operating system for the computer system 525 is provided in the system memory, the hard drive, the CD-ROM 540 or other computer readable storage medium and serves to incorporate the computer code that implements the invention.

The various aspects, features, embodiments or implementations of the invention described above can be used alone or in various combinations.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of the invention is that more sophisticated media messages can be sent than was previously possible. Another advantage is in the integration of the received media message with a media management application rather than with a web browser as is currently common. Another advantage is that information about multiple albums by a single artist may be sent in a single message. Yet another advantage is that a common media message can be easily sent to a plurality of recipients.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for communicating information about media items, said method comprising:
browsing or searching for media items in a media repository on a first remote server computer using a client application running on a first client computer;
receiving information from the media repository regarding a plurality of media items;
displaying the information regarding the plurality of media items;
sending a media information share request to a second remote server computer;
receiving a media message form from the second remote server computer;
displaying the media message form, the media message form including media item information pertaining to the one or more of the plurality of media items associated with the media information share request, and the media message form including a plurality of text fields to be completed;
receiving user-provided information for at least one of the text fields in the media message form to complete the media message form;
detecting a request to send the completed media message form to one or more recipients; and
submitting the completed media message form to the second remote server computer for transmission to the one or more recipients.

2. A computer-implemented method as recited in claim 1, wherein the client application is not a network browser program.

3. A computer-implemented method as recited in claim 1, wherein the first remote server computer is the same the second remote server computer.

4. A computer-implemented method as recited in claim 1, wherein said sending of the media information share request being initiated by a single user interface action.

5. A computer-implemented method as recited in claim 1, wherein said method further comprises:
ensuring, at the client application, that the media message form has been completed by a user.

6. A computer-implemented method as recited in claim 1, wherein the media item information included in the media message form is comprises graphical information pertaining to the one or more of the plurality of media items associated with the media information share request.

7. A computer-implemented method as recited in claim 1, wherein at least one of the text fields of the media message form permits a user to enter a plurality of recipient e-mail addresses.

8. A computer-implemented method as recited in claim 1, wherein the user-provided information includes at least a plurality of recipient e-mail addresses.

9. A computer-implemented method as recited in claim 1, wherein the text fields in the media message form include at least text fields for entry of a plurality of recipient e-mail addresses for one or more recipients, a name of the user, an e-mail address for the user, and an optional message to the recipients.

10. A computer-implemented method as recited in claim 1, wherein after said displaying of the information regarding the plurality of media items, and before said sending of the media information share request to a second remote server computer, said method further comprises:
formulating the media information share request for one or more of the plurality of media items.

11. A computer-implemented method as recited in claim 1, wherein the media item information included within the media message form pertains to a plurality of the media items associated with the media information share request.

12. A computer-implemented method as recited in claim 11, wherein said method comprises:
displaying the media message form, the media message form including media item information pertaining to the plurality of the media items associated with the media information share request.

13. A computer-implemented method as recited in claim 12, wherein the media item information included in the media message form is comprises graphical information pertaining to the plurality of media items associated with the media information share request.

14. A computer-implemented method as recited in claim 13, wherein the media items associated with the media information request are albums of songs, and wherein the graphical information is album artwork.

15. A computer-implemented method for communicating information about media files, comprising:
browsing or searching for media files in a media repository on a remote server computer using a client application running on a first client computer;
receiving, at the client application, information from the media repository regarding a plurality of media files;
displaying, at the client application, information regarding the media files along with album and artist information associated with the media files;
detecting, at the client application, a request by a user to share information about an artist or album;
formulating, at the client application, a media information share request for the artist or album;
sending the media information share request to the remote server computer;
receiving, at the client application, a media message form displaying artist or album information according to the user's media information share request, wherein the media message form contains blanks directing the user to enter a plurality of recipient e-mail addresses, the user's name and e-mail address, and an optional message to the recipients;
detecting, at the client application, a request by the user to send the media message form to the recipients;
ensuring, at the client application, that the media message form has been completed by the user; and
submitting the completed media message form to the server computer.

16. A computer-implemented method as described in claim 1, further comprising
receiving an e-mail at a second client computer;
executing, in a web browser at the second client computer, a hyperlink in the e-mail;
opening, at the client computer, an HTML page which contains embedded code;
determining, using the embedded code, if a media management application is installed on the client computer;
if a media management application is installed:
launching the media management application;
directing the media management application to the media repository according to the information contained in the e-mail; and
if a media management application is not installed:
directing the user, using the web browser, to a hyperlink which allows the user to install the media management application.

17. The computer-implemented method of claim 16, wherein the e-mail contains hyperlinked musical artist information comprising a plurality of music albums by the musical artist.

18. The computer-implemented method of claim 20, wherein the e-mail contains hyperlinked information about a music album.

19. A computer-implemented method for communicating information about media files, comprising:
(a) receiving, at a server computer, a media information share request from a client computer, wherein the media information share request is for artist or album information;
(b) retrieving, at the server computer, artist or album information according to the media information share request;
(c) constructing, at the server computer, a media message form, wherein the media message form contains an artist or album information according to the media information share request and blanks boxes wherein the user can enter a plurality of recipient e-mail addresses, the user's name and e-mail address, and a message to the recipients; and
(d) sending the completed media message form to the client computer.

20. A computer-implemented method as described in claim 19, further comprising:
(e) receiving, at a server computer, a completed media message form from a client computer;
(f) constructing, at the server computer, a media message, wherein the media message contains artist or album information according to the media message form;
(g) extracting, at the server computer, a list of e-mail addresses from the media message form;
(h) selecting an e-mail address from the list of e-mail addresses;
(i) sending a media message to the selected e-mail address; and
(j) repeating (h)-(i) for each e-mail address in the list of the mail addresses.

21. A computer-implemented method as described in claim 19, wherein the media message is in HTML format.

22. A computer-implemented method as described in claim 20, wherein the media message is in plain text format.

23. The computer-implemented method of claim 20, wherein the media message comprises an e-mail including hyperlinked musical artist information comprising a plurality of music albums by the musical artist.

24. The computer-implemented method of claim 20, wherein the media message comprises an e-mail including hyperlinked information about a music album.

25. The computer-implemented method of claim 20, wherein the list of e-mail addresses is comma-delimited.

26. A computer-implemented method for communicating information about media files, comprising:
(a) receiving, at a server computer, a completed media message form from a client computer;
(b) constructing, at the server computer, a media message, wherein the media message contains artist or album information according to the media message form;
(c) extracting, at the server computer, a list of e-mail addresses from the media message form;
(d) selecting an e-mail address from the list of e-mail addresses;
(e) sending a media message to the selected e-mail address; and
(f) repeating (d)-(e) for each e-mail address in the list of the mail addresses.

27. A computer readable media, comprising:
computer code for browsing or searching for media items in a media repository on a first remote server computer using a client application running on a first client computer;
computer code for receiving information from the media repository regarding a plurality of media items;
computer code for displaying the information regarding the plurality of media items;
computer code for sending a media information share request to a second remote server computer;
computer code for receiving a media message form from the second remote server computer;
computer code for displaying the media message form, the media message form including media item information pertaining to the one or more of the plurality of media items associated with the media information share request, and the media message form including a plurality of text fields to be completed;
computer code for receiving user-provided information for at least one of the text fields in the media message form to complete the media message form;
computer code for detecting a request to send the completed media message form to one or more recipients; and
computer code for submitting the completed media message form to the second remote server computer for transmission to the one or more recipients.

28. A computer readable medium, comprising:
computer code for browsing or searching for media files in a media repository on a remote server computer using a client application running on a first client computer;
computer code for receiving, at the client application, information from the media repository regarding a plurality of media files;
computer code for displaying, at the client application, information regarding the media files along with album and artist information associated with the media files;
computer code for detecting, at the client application, a request by a user to share information about an artist or album;
computer code for formulating, at the client application, a media information share request for the artist or album;
computer code for sending the media information share request to the remote server computer;
computer code for receiving, at the client application, a media message form displaying artist or album information according to the user's media information share request, wherein the media message form contains blanks directing the user to enter a plurality of recipient e-mail addresses, the user's name and e-mail address, and an optional message to the recipients;
computer code for detecting, at the client application, a request by the user to send the media message form to the recipients;
computer code for ensuring, at the client application, that the media message form has been completed by the user; and
computer code for submitting the completed media message form to the server computer.

29. A computer readable media, comprising:
computer code for receiving, at a server computer, a media information share request from a client computer, wherein the media information share request is for artist or album information;
computer code for retrieving, at the server computer, artist or album information according to the media information share request;
computer code for constructing, at the server computer, a media message form, wherein the media message form contains an artist or album information according to the media information share request and blanks boxes wherein the user can enter a plurality of recipient e-mail addresses, the user's name and e-mail address, and a message to the recipients; and
computer code for sending the completed media message form to the client computer.

30. A computer readable medium, comprising:
computer code for (a) receiving, at a server computer, a completed media message form from a client computer;
computer code for (b) constructing, at the server computer, a media message, wherein the media message contains artist or album information according to the media message form;
computer code for (c) extracting, at the server computer, a list of e-mail addresses from the media message form;
computer code for (d) selecting an e-mail address from the list of e-mail addresses;
computer code for (e) sending a media message to the selected e-mail address; and
computer code for a repeating (d)-(e) for each e-mail address in the list of the mail addresses.
